(19) United States
(12) Patent Application Publication
(10) Pub. No.: US 2009/0213582 A1
(43) Pub. Date: Aug. 27, 2009

(54) Illuminated Display

(76) Inventor: Blair Lamar Thomas, King of Prussia, PA (US)

Correspondence Address: Blair Lamar Thomas, 401 Gulph Ridge Drive, King of Prussia, PA, 19406, US

(21) Appl. No.: 12/358,235

(22) Filed: Jan. 22, 2009

Related U.S. Application Data
(60) Provisional application No. 61/006,671, filed on Jan. 25, 2008.

(51) Int. Cl. F21L 4/00; F21V 21/00

(52) U.S. Cl. 362/183; 362/398

(57) ABSTRACT

A display device that can be mounted to a surface, such as a car or refrigerator using magnetic attraction. The display device has an illumination element, such as an LEC panel, is powered preferably by battery or solar power, and is lightweight and flexible. The illumination element has a film that preferably displays indicia that is lit up by the illumination element.

### BACKGROUND OF THE INVENTION

1. Field of the Invention

The present invention is generally directed to a display element and more particularly to an illuminated display element or an illuminated magnet or magnetic display element.

2. Description of the Prior Art

Magnets and magnetic signs have long been used in a variety of applications, such as displaying words or some kind of image that is reproduced and attached to one side of the magnet with the opposite side of the magnet attached to a refrigerator, a car, or some other magnetically attractive surface. For example, magnetic signs that are displayed on vehicles are used to advertise information about a company or business, a product for sale, or even to display a team name, slogan, mascot, logo, etc. However, none of these magnets can be seen in the dark unless a light is shining on them and therefore, are not being used to their full potential.

### SUMMARY OF THE INVENTION

The present invention relates to a unique illuminated magnet. The magnet includes a back or bottom layer of magnetic material with sufficient magnetic force to be held on a magnetically attractive surface, such as steel or other ferritic materials. The front or top layer of the magnet can have any type of display or image such as a picture or set of words. These magnets can display company or business information, advertisements, a team mascot, logo, etc. or anything that a user wishes to display. To overcome the shortcomings of the prior art magnets, which can't be seen in the dark, the present invention provides illumination to the magnet such that the display on the front or top layer is visible in the dark. In addition, the magnet can incorporate a sensor that is coupled to the illumination element such that when the sensor senses a certain level of darkness, it triggers the illumination element via the coupling to an ‘on’ position to illuminate the display. Another embodiment of the invention incorporates a solar power assembly that is coupled to the illumination element so that natural sunlight or artificial light is captured by the solar power assembly to provide the energy needed to power the illumination element. In lieu of a solar power assembly, a battery power may also be used to energize the illumination device. The battery can be a small button battery that is thin and lightweight. The solar power or battery assembly or the illumination element can have an override switch that cuts off power from the energy source or to the illumination element, respectively.

The preferred embodiment has a very small thickness since the components are small, thin, and can be embedded within the device. The illumination element is preferably a flexible, flat panel LEC device. This allows the thickness to be minimal and the device to be lightweight. The device can be quickly attached to or removed from a surface such as a refrigerator or car without causing damaging surface or device.

### BRIEF DESCRIPTION OF THE DRAWINGS

FIG. 1A is a front view of a first embodiment of the present invention.

FIG. 1B is a side cross-sectional view of the first embodiment of the present invention.

FIG. 2A is a front view of a second embodiment of the present invention.

FIG. 2B is a side cross-sectional view of the second embodiment of the present invention.

FIG. 3A is a front view of a third embodiment of the present invention.

FIG. 3B is a side cross-sectional view of the third embodiment of the present invention.

FIG. 4A is a front cross-sectional view of the first embodiment of the present invention.

FIG. 4B is a side cross-sectional view of the fourth embodiment of the present invention.

FIG. 5A is a front view of a fifth embodiment of the present invention.

FIG. 5B is a side cross-sectional view of the fifth embodiment of the present invention.

FIG. 6A is a front view of a sixth embodiment of the present invention.

FIG. 6B is a side cross-sectional view of the sixth embodiment of the present invention.

FIG. 7A is a front view of a seventh embodiment of the present invention.

FIG. 7B is a side cross-sectional view of the seventh embodiment of the present invention.

FIG. 8 is a side cross-sectional view of the present invention showing embedded inverter.

FIG. 9 is a front view of the another embodiment of the present invention.

FIG. 10 is a front view of the present invention showing a protective covering.

### DETAILED DESCRIPTION OF THE PREFERRED EMBODIMENTS

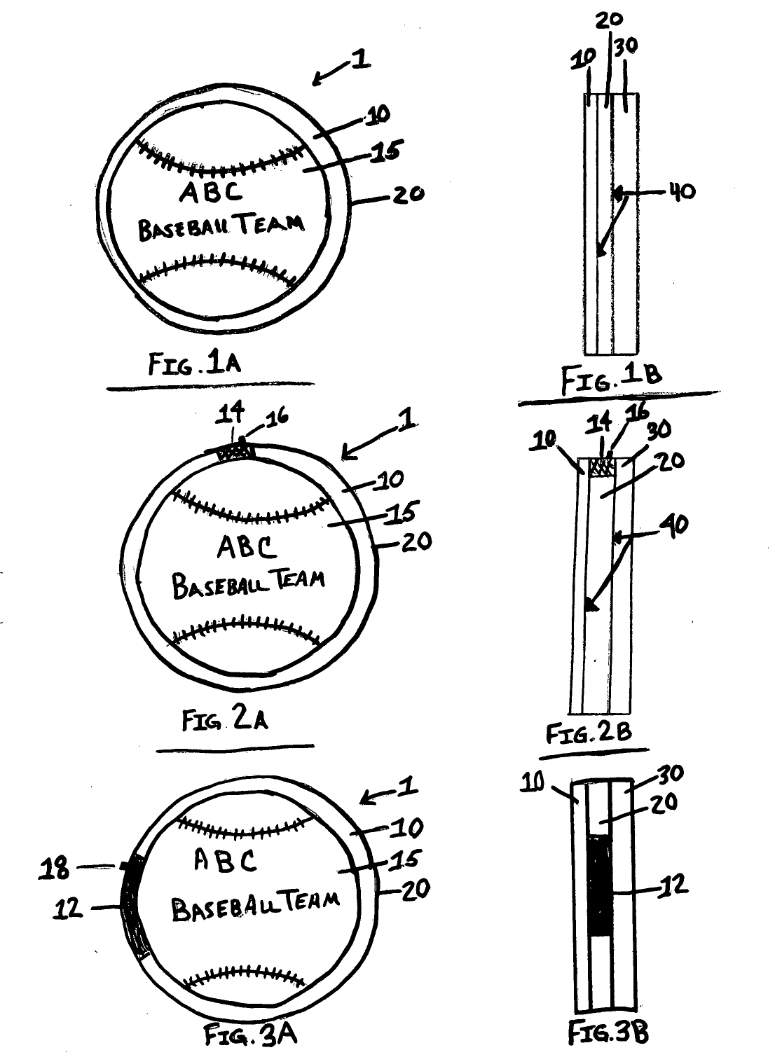

The first embodiment is generally shown in FIGS. 1A and 1B. The illuminated device, such as an illuminated magnet device of the present invention is designated generally in the figures as element 1. Device 1 includes a bottom or back layer 30. Preferably the back layer is made of magnetic material. The device 1 also includes a top/front side layer or film 10, preferably a transparent layer, for displaying at least one indicium or image 15, such as but not limited to, company or business name, advertising, slogan, logo, picture, team name, mascot, words or symbols. An illumination element or panel 20 is located within or behind the top/front side layer or film 10 to illuminate display on layer 10. Illuminated element 20 is preferably located between elements 10 and 30. The layers 10, 20, 30 of the device may be molded as one piece or combination of pieces or may by separate pieces/layers which are attached by any known means 40, such as but not limited to, glue, pressure sensitive adhesive (PSA), welding, any known mechanical fasteners, magnetic means, etc. The illumination element includes a power source that can be AC/DC, battery, or solar powered, and is preferably attached to or embedded within the magnetic layer or is attached to or embedded within the illumination device or sandwiched between the magnetic layer and illumination element. The power source can be protected by a housing, preferably made of flexibly material. The power source is preferably coupled to an electrical circuit that connects to the illumination element, such as with electrical conductors, as well known in the art. However, it is not limited to such circuitry and any known equivalents may be used.

FIG. 4A shows a front cross-section of the device showing the top display layer 10 with image 15 displayed thereon. Middle layer or illuminated element 20 is shown, as well as back layer 30.

A second embodiment is generally shown in FIGS. 2A and 2B. Like elements of the first embodiment are also shown in these figures. As is shown, the illuminated magnet 1 of the second embodiment is similar to that of the first embodiment but includes a light/darkness sensor 14 that is provided on or within the top or front layer 10 to detect a degree of darkness. The sensor 14 is coupled to the illumination element 20 so that when a certain level of darkness is detected by sensor 14, it will trigger illumination to an “on” position to illuminate the display on the front side 10 to be visible in low light. Once the sensor detects a certain level of light from the outside environment, it will trigger the illumination element 20 to an “off” position to stop illuminating the display which is now visible in the natural or artificial light sensed by sensor.

The sensor (14) or illumination device can also be equipped with an override switch 16 that can override the “off” position so that the illumination element 20 will be ‘on’ no matter how much light the sensor is detecting, or the override switch 16 can override the “on” position so that the illumination element 20 is turned off no matter how little light is detected by sensor 14.

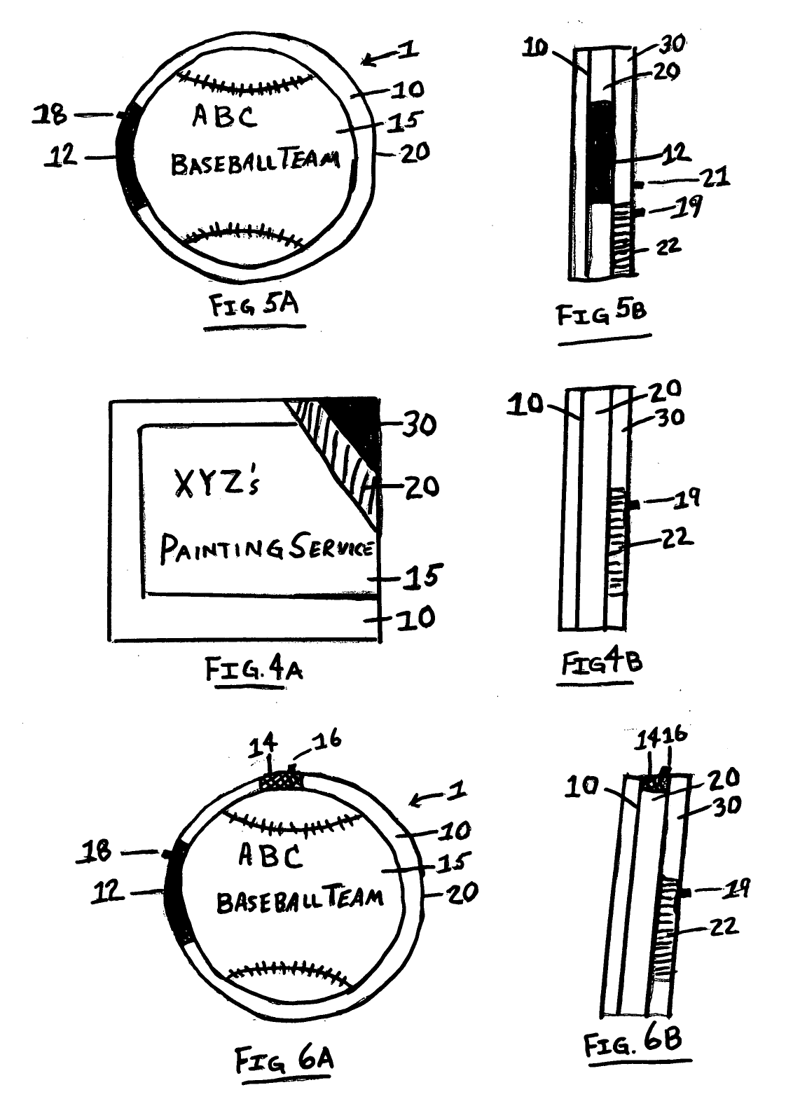

A third embodiment is generally shown in FIGS. 3A and 3B. Like elements of the first embodiment are also shown in these figures. As is shown, the illuminated magnet 1 of the third embodiment is similar to that of the first embodiment but includes the addition of a solar power assembly 12. The solar power assembly 12 extends the life of the illuminated magnet 1 by allowing the illumination element 20 to be powered with solar or artificial light energy that is captured by the solar power assembly 12 and transferred via a coupling to the illumination element 20 so that the illumination element 20 is rechargeable and able to be lit and relit for extended periods of time. An optional circuit switch 18 is connected to the solar power assembly 12 in order to turn power on/off to the illuminating element 20.

A fourth embodiment is shown in FIG. 4B. This embodiment is similar to the third embodiment. However, instead of a solar power assembly the magnet includes a battery assembly 22. The battery assembly 22 is coupled to the illumination element 20 and provides power to illuminate element 20. The battery assembly 22 can house a standard or rechargeable battery(ies). An optional circuit switch 19 is connected to the battery power assembly 22 in order to turn power on/off to the illuminating element 20.

A fifth embodiment is shown in FIGS. 5A and 5B. This embodiment incorporates the third and fourth embodiment in that the illuminated magnet 1 is equipped with a solar power assembly 12 and a battery powered assembly 22. This embodiment allows either assembly to be the source of energy to power the illuminating element 20. Optional circuit switch 21 can be used to determine the energy source. The switch 21 can be placed in an ‘off’ position that does not allow power to illumination element 20 or in one of two ‘on’ positions: 1) in the solar power position to allow the solar power assembly 12 to energize the illumination element 20 or 2) in the battery powered position to energize the element 20 via the battery source. The battery assembly 22 can house a standard or rechargeable battery(ies). The battery assembly 22 may also use the solar power assembly 12 to recharge a rechargeable battery(ies) housed therein.

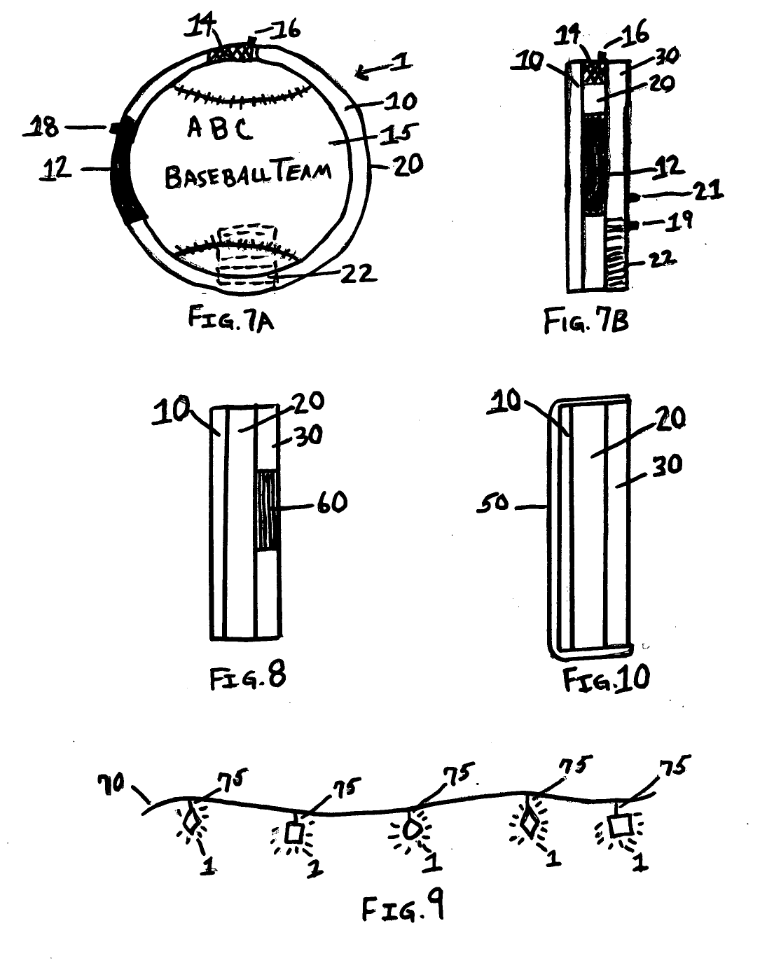

A sixth embodiment is shown in FIGS. 6A and 6B. This embodiment incorporates the third (FIG. 6A) or fourth embodiment (FIG. 6B) with the sensor of the second embodiment. More particularly, the illuminating magnet 1 includes the power source of either the solar assembly 12 of the third embodiment or the battery assembly 22 of the fourth embodiment wherein the power source is coupled to the illuminating element 20 and includes the sensor of the second embodiment. The sensor 14 is coupled to the power assembly 12 or 22 so that when a certain level of darkness is detected by sensor 14, it will trigger illumination element 20, via the power source (12 or 22), to an “on” position to illuminate the display on the front side 10 to be visible in low light. Once the sensor detects a certain level of light from the outside environment, it will trigger the illumination element 20, via the power source, to an “off” position to stop illuminating the display which is now visible in the natural or artificial light sensed by sensor.

An optional circuit switch 18 or 19 is connected to the solar power assembly 12 or battery assembly 22, respectively, in order to override the sensor 14 to turn on/off the illuminating element 20 regardless of the light/darkness detected by sensor 14.

Of course instead of having switch 18 or 19 to override the sensor, the sensor or illumination device can also be equipped with an override switch 16 that can override the “off” position so that the illumination element 20 will be ‘on’ no matter how much light the sensor is detecting, or the override switch 16 can override the “on” position so that the illumination element 20 is turned off no matter how little light is detected by sensor 14.

A seventh embodiment is shown in FIGS. 7A and 7B. This embodiment incorporates the fifth embodiment with the sensor of the second embodiment. More particularly, the illuminating magnet 1 includes the power sources of the solar assembly 12 and the battery assembly 22. Optional circuit switch 21 can be used to determine the energy source. The switch 21 can be placed in an ‘off’ position that does not allow power to illumination element 20 or in one of two ‘on’ positions: 1) in the solar power position to allow the solar power assembly 12 to energize the illumination element 20 or 2) in the battery powered position to energize the element 20 via the battery source. The battery assembly 22 can house a standard or rechargeable battery(ies). The battery assembly 22 may also use the solar power assembly 12 to recharge a rechargeable battery(ies) housed therein.

The magnet 1 also includes the sensor 14 which is coupled to the power sources so that when a certain level of darkness is detected by sensor 14, it will trigger illumination element 20, via one of the power sources (12,22), to an “on” position to illuminate the display on the front side 10 to be visible in low light. Once the sensor detects a certain level of light from the outside environment, it will trigger the illumination element 20 to an “off” position, via the power sources, to stop illuminating the display which is now visible in the natural or artificial light sensed by sensor.

An optional circuit switch 18,19 is connected to the solar power assembly 12 or battery assembly 22, respectively, in order to override the sensor 14 to turn on/off the illuminating element 20 regardless of the light/darkness detected by sensor 14.

Of course instead of having switch 18 or 19 to override the sensor, the sensor or illumination device can also be equipped with an override switch 16 that can override the “off” position so that the illumination element 20 will be ‘on’ no matter how much light the sensor is detecting, or the override switch 16 can override the “on” position so that the illumination element 20 is turned off no matter how little light is detected by sensor 14.

Any of the embodiments referred herein may have an interchangeable or replaceable top or front layer/film 10. This will allow different layers/films 10 to be interchanged or replaced while using only one illumination element 20. Therefore, a user can have versatility in using the illumination element. For instance, a user can display a favorite sports team logo during football season and display a different team's logo during baseball season. This allows great flexibility for using the illumination element with any number of layers/films 10. Since only one illumination element is needed, the cost will be lower for user because different displays can be utilized without the need to buy the entire device for each display desired.

To replace one display with another, different methods can be incorporated. Any known means to releasably attach the layer/film 10 can be used. One option is to use a pressure sensitive adhesive PSA that has enough tackiness to hold layer/film 10 on panel 20 during use, but can be readily detached, replaced with another display and reused later without damage to the illumination panel 20 or to layer/film 10. A second option is to use a film having static cling properties that will removably attach the layer/film 10 to the panel 20. Another option could be mechanical means, such as clamps, snaps, latches, hook and loop, etc. Another option could be the use of attractive magnetic forces wherein the display 10 incorporates one magnetic force and the illuminated panel 20 incorporates a second opposite magnetic force. Another option would be to incorporate a magnetic material within the display 10 or within the illumination panel 20 and incorporate a magnetically attractive surface, such as steel or other ferritic material within the other of the two elements, the illumination panel 20 or the display 10, respectively. In addition, if the magnetic layer 30 is strong enough, then the illumination panel 20 may be made any magnetic material, and the layer 30 would have attractive forces strong enough to hold the display 10 that would have a material attractive to magnetic layer 30 and strong enough to hold/attract the illumination element, as well.

The illumination element 20 can be any known type of lighting means such as, but not limited to, LCD, LED, halogen, UV, fluorescent, EL (electroluminescent lighting), and LEC (light emitting capacitor). Light Emitting Capacitor technology uses phosphors sandwiched between a series of electrodes. A changing field, generated by a voltage, within the phosphors causes the phosphors to emit light. The LEC components are encapsulated in flexible, semi-rigid, or rigid materials. The illumination element 20 most preferably consists of a thin, flat LEC panel. Preferably the LEC panel is flexible and can have any desired shape. The thinness of the LEC panel allows for the overall thickness of the device 1 to be no more than 1 inch thick. More preferably the overall thickness of the entire device including the magnetic back layer, the illumination panel, and the front film is no more than ½ inch thick, and most preferably the overall thickness of the device is no more than ¼ inch thick. Any portion of the panel can be illuminated. For instance, the entire panel can be illuminated, or just the edge. Or, the image on film 10 overlying the panel 20 can be selectively illuminated by illuminating specific areas of the image, such as, just the outline of the image or only the interior of the image. Any combination of illumination areas is possible.

If the illuminating source, such as an LEC panel, requires certain voltage and/or frequency needs, an inverter 60 can be used. The inverter converts AC or DC electrical current to required panel voltage and frequency. The inverter 60 can be powered by any known sources, such as but not limited to, an electric source, by batteries or by solar power. Preferably the inverter 60 is battery powered which can be rechargeable if desired. The inverter 60 is preferably dimensioned to be embedded within the device 1 such that the thickness of the inverter 60 does not exceed the overall thickness of the device 1 (FIG. 8). If necessary a spacer or filler material can be used between magnetic layer 30 and illumination element/panel 20 so that the overall thickness of the device 1 is at least equal to the thickness of the inverter 60. The entire outer edge of the device 1 may be sealed. An inverter 60 is capable of being used, if necessary, for all embodiments disclosed herein.

Another embodiment can incorporate the LEC panel 20 and top layer 10 with an embedded inverter 60 without a magnetic back layer. This embodiment can also incorporate one or a combination of the elements disclosed herein, such as, a light sensor, a solar assembly, battery power, override switch, and have magnetic or other means for releasably connecting the elements together.

Another embodiment is shown in FIG. 9. This shows a plurality of individual displays 1 that are placed in sequence on a light string 70, such as an electric wire, similar to Christmas lights. The individual displays 1 are attached to the power string/wire by connecting one end of the each display to a receiving end of one of a plurality of connectors 75 spaced along the string/wire to string a series of displays in a row that can be lit. In a preferred embodiment, each connector 75 on the wire/string receives an end of an inverter that is attached or housed in the display to light display.

All embodiments can have a back layer having an opening with a closure or have a casing disposed in the opening to hold and protect inverter and/or battery assembly.

All embodiments can have an optional protective layer 50, as shown in FIG. 10 that protects the display on the top side and/or around the side edges to seal against debris. The protective layer 50 is preferably a laminate layer and can cover any amount of the front side up to the edge(s) or can extend over the outer edge(s) to protect all sides of the device. The laminate protective sheet or covering can be a laminate, a coating that is applied over the top and/or side surfaces or can be a curable coating that is sprayed onto the surfaces desired to be protected.

The illuminated display with or without magnetic material can come in any size and shape desired.

It is possible the sensor not only detects light, but motion as well. It is also possible to have a sensor that only detects motion to trigger the power on to illuminate the device.

While certain preferred embodiments of the present invention have been discussed, it is understood that various modifications may be made without departing from the spirit of the invention or scope of the following claims.

1. A display device comprising:
a backing layer of magnetic material;
a power supply;
an illumination element coupled to the power supply and attached to the backing layer;
and a film disposed upon the illumination element.

2. The display device according to claim 1, wherein the film includes at least one indicium.

3. The display device according to claim 2, wherein the at least one indicium is selected from the group of alphanumeric characters, pictures, photographs, symbols, logos, trademarks.

4. The display device according to claim 1, wherein the power supply is a battery or a solar power assembly.

5. The display device according to claim 1, wherein the power supply includes a battery and a solar power energy assembly.

6. The display device according to claim 1, wherein the device further includes a light sensor or a motion sensor or both a light and motion sensor.

7. The display device according to claim 4, wherein the device further includes a light sensor or a motion sensor or both a light and motion sensor.

8. The display device according to claim 5, wherein the device further includes a light sensor or a motion sensor or both a light and motion sensor.

9. The display device according to claim 1, wherein the film is adhesively or magnetically attached to the illumination element and the illumination element is adhesively or magnetically attached to the magnetic backing layer.

10. The display device according to claim 1, wherein the power supply includes an inverter.

11. The display device according to claim 1, wherein the illumination element is a flat, flexible LEC panel.

12. A display device comprising:
a backing layer of magnetic material;
a power supply;
an illumination element coupled to the power supply and attached to the backing layer, wherein the illumination element is a flat, flexible LEC panel;
and a film disposed upon the illumination element.

13. The display device according to claim 12, wherein the power supply includes an inverter.

14. The display device according to claim 12, wherein the film includes at least one indicium selected from the group of alphanumeric characters, pictures, photographs, symbols, logos, trademarks.

15. The display device according to claim 12, wherein the power supply is a battery or a solar power assembly.

16. The display device according to claim 12, wherein the power supply includes a battery and a solar power energy assembly.

17. The display device according to claim 12, wherein the device further includes a light sensor or a motion sensor or both a light and motion sensor.

18. The display device according to claim 15, wherein the device further includes a light sensor or a motion sensor or both a light and motion sensor.

19. The display device according to claim 16, wherein the device further includes a light sensor or a motion sensor or both a light and motion sensor.

20. The display device according to claim 12, wherein the film is adhesively or magnetically attached to the illumination element and the illumination element is adhesively or magnetically attached to the magnetic backing layer.
